(19) United States
(12) Patent Application Publication
(10) Pub. No.: US 2025/0052206 A1
(43) Pub. Date: Feb. 13, 2025

(54) EXHAUST VALVE CONTROLLER FOR TWO-STROKE ENGINES

(71) Applicant: Arctic Cat Inc., Thief River Falls, MN (US)

(72) Inventors: Carson Price, Minnetonka, MN (US); Jeremy Mammen, Thief River Falls, MN (US); Cord Miller Christensen, Goodridge, MN (US); Alexander Konrad Fuhrman, Thief River Falls, MN (US)

(21) Appl. No.: 18/230,945

(22) Filed: Aug. 7, 2023

Related U.S. Application Data
(63) Continuation-in-part of application No. 17/744,210, filed on May 13, 2022, now Pat. No. 11,761,358.
(60) Provisional application No. 63/310,994, filed on Feb. 16, 2022.
(60) Provisional application No. 63/404,749, filed on Sep. 8, 2022.

(51) Int. Cl. F02D 13/02

(52) U.S. Cl. CPC F02D 13/0242; F02D 13/028; F02B 2075/025; F02D 2200/101; F02D 2400/04

(57) ABSTRACT

An exhaust valve includes a toroidal surface about an axis of rotation of the valve. The toroidal surface is positionable over a central exhaust port of an engine when lowered. The valve is raised by an actuator in response to increasing rotational speed of the crankshaft of the engine, thereby enlarging and raising the effective opening of the exhaust port. Lateral valve surfaces on either side of the toroidal surface close lateral exhaust ports when the valve is lowered. The lateral valve surfaces may be cylindrical and formed on fins. The position of the exhaust valve is adjusted continuously along its range of motion and the position of the exhaust valve may be calculated based on some or all of engine speed, engine loading, and exhaust temperature at a frequency up to once per revolution of the engine.

### RELATED APPLICATIONS

This application is a continuation-in-part application of U.S. application Ser. No. 17/744,210, filed May 13, 2022, entitled MULTI-PORT EXHAUST VALVE FOR TWO-STROKE ENGINES, which claims priority to U.S. Provisional Application Ser. No. 63/310,994, filed Feb. 16, 2022, entitled TWO-STROKE ENGINE; and U.S. Provisional Application Ser. No. 63/404,749, filed Sep. 8, 2022, entitled TWO-STROKE ENGINE, which is hereby incorporated herein by reference in its entirety.

### FIELD OF THE DISCLOSURE

This application relates to two-stroke engines and, more particularly, to exhaust valves for two-stroke engines.

### BACKGROUND

Two-stroke engines have an excellent power-to-weight ratio and have fewer moving parts relative to four-stroke engines. Two-stroke engines are therefore the engine of choice in applications where weight is critical, such as snowmobiles, off-road motorcycles, and landscaping tools.

The low weight and simplicity of a two-stroke engine sometimes comes at the cost of efficiency. A two-stroke engine includes a piston that slides within a cylinder. The piston is coupled to a crank within a crankcase and the crank is rotated by the piston. A two-stroke engine lacks cam-actuated valves as are used in a four-stroke engine. Instead, ports are formed in the cylinder wall: an exhaust port that is closer to the top of a cylinder and an intake port that is closer to the crankcase than the exhaust port. The intake port is connected to the crankcase such that as the piston moves toward the crankcase, air displaced by the piston is urged into the cylinder through the intake port. As the piston moves away from the crankcase, a one-way valve allows air to enter the crankcase.

The sequence of events in the operation of a two-stroke engine are as follows:
1. The piston moves toward the crankcase until the top of the piston is below the intake port. This forces air into the cylinder through the intake port.
2. The piston moves away from the crankcase and past the intake port and past the exhaust port until the piston reaches top dead center (TDC), thereby compressing air in the cylinder. Fuel may be mixed with the air while it is drawn into the crankcase and/or injected during or after compression.
3. A spark plug ignites the air-fuel mixture in the cylinder.
4. The combustion of the air-fuel mixture forces the piston toward the crankcase.
5. As the piston passes the exhaust port, combustion gas is allowed to exit through the exhaust port.
6. The process repeats at 1.

The inefficiency of a two-stroke engine arises from various factors. First, the presence of the intake and exhaust ports limits the compression ratio for a given length of piston travel. Second, the exhaust port and intake port are both uncovered at the same time such that fuel-air mixture might escape through the exhaust port where injection is not used.

Due to the excellent power-to-weight ratio of two-stroke engines, they are widely used despite these deficiencies. Many approaches are used to overcome these deficiencies at least partially. One of these is an exhaust valve that varies the effective height of the exhaust port. At low engine speed (i.e., revolutions-per-minute or “RPM”), greater power is achieved if the exhaust valve is lower, since the volume of air that is being compressed is greater. At high RPMs, greater power is achieved if the exhaust valve is higher since exhaust gases are allowed to begin exiting sooner.

It would be an advancement in the art to provide an improved exhaust valve for use in two-stroke engines.

### SUMMARY

In one aspect of the invention, an engine includes a valve body defining an axis of rotation and a central valve surface, the central valve surface conforming to a first shape that is symmetric about the axis of rotation. The engine further includes a cylinder wall defining a cylinder, a central exhaust port, and one or more intake ports. A cavity outside of the cylinder is in fluid communication with the central exhaust port and is sized to receive the valve body such that the central valve surface is rotatable relative to the central exhaust port between a low position and a high position, the central valve surface covering a greater amount of the central exhaust port in the low position. A piston is positioned within the cylinder and a crankshaft is coupled to the piston. A speed sensor is configured to sense an angular speed of the crankshaft and an actuator is coupled to the valve body. An electronic control unit is coupled to the speed sensor and the actuator. The electronic control unit is programmed to cause the actuator to adjust a position of the valve body in increments of less than or equal to 10 percent of a range of motion of the valve body based on outputs of the speed sensor.

In some embodiments, the electronic control unit is programmed to cause the actuator to adjust the position of the valve body in increments of less than or equal to 1 percent of the range of motion of the valve body based on the outputs of the speed sensor. The electronic control unit may be programmed to cause the actuator to adjust the position of the valve body in increments of less than or equal to 1 degree based on the outputs of the speed sensor. The electronic control unit may be programmed to cause the actuator to adjust the position of the valve body in increments of less than or equal to 0.1 degrees based on the outputs of the speed sensor. The electronic control unit may be programmed to adjust the position of the valve body at an angular speed of rotation that is less than the angular speed of the crankshaft. The electronic control unit may be programmed to calculate the position of the valve body at least once per revolution of the crankshaft.

In some embodiments, the electronic control unit is programmed to sense loading of the crankshaft and to adjust the position of the valve body based on both of the outputs of the speed sensor and the loading. The electronic control unit may be programmed to move the valve body closer to the high position with increasing engine speed as indicated in the outputs of the speed sensor. The electronic control unit may be programmed to move the valve body closer to the high position with increasing of the loading. The electronic control unit may be programmed to sense an exhaust temperature of an exhaust temperature of exhaust expelled through the central exhaust port and to adjust the position of the valve body based on both outputs of the speed sensor and the exhaust temperature. In some embodiments, the electronic control unit is programmed to calculate an expected temperature based on the loading the outputs of the speed sensor; obtain a difference between the exhaust temperature and the expected temperature; and adjust the position of the valve body based on the difference.

In some embodiments, the central valve surface does not completely cover the central exhaust port when in the low position. In some embodiments, the first shape is a circular toroid. The valve body may further include a first lateral valve surface defined by the valve body, the first lateral valve surface conforming to a second shape that is different from the first shape and that is symmetric about the axis of rotation. The valve body may further include a second lateral valve surface defined by the valve body, the central valve surface being positioned between the first lateral valve surface and the second lateral valve surface, the second lateral valve surface conforming to a third shape that is different from the first shape and that is symmetric about the axis of rotation, the second shape and the first shape each being a cylinder.

In another aspect of the invention, a method for controlling a two-stroke engine includes measuring a speed of the two-stroke engine; and adjusting, by a controller, a position of a valve body controlling opening of an exhaust port of the two-stroke engine in an increment of less than or equal to 10 percent of a range of motion of the valve body based on the speed.

In some embodiments, the method further includes measuring a loading of the two-stroke engine; and adjusting, by the controller, the position of the valve body based on the speed and the loading. The method may further include measuring an exhaust temperature of the two-stroke engine; and adjusting, by the controller, the position of the valve body based on the speed, the loading, and the exhaust temperature.

In some embodiments, the method includes calculating, by the controller, an expected temperature based on the loading the speed of the two-stroke engine; obtaining, by the controller, a difference between the exhaust temperature and the expected temperature; and adjusting, by the controller, the position of the valve body based on the difference.

In some embodiments, the method includes adjusting, by the controller, the position of the valve body at an angular speed of rotation that is less than the speed of the two-stroke engine. The method may further include calculating, by the controller, the position of the valve body at least once per revolution of a crankshaft of the two-stroke engine. In some embodiments, the central valve surface does not completely cover the central exhaust port when in the low position.

The present disclosure also includes a method for installing an exhaust valve in an engine. An exhaust valve assembly includes a valve body and a pivot rod. The method includes inserting the valve body and the pivot rod into an opening adjacent to a cylinder in the engine. Once inserted, a cover is secured over the opening. Preferably, bushings or bearings are secured on the pivot rod before insertion. The cover is removable without removal of a cylinder head or another exhaust component.

In another embodiment an exhaust assembly includes a first and second main valve bodies with first and second main valve faces positioned adjacent to first and second engine cylinders. The first valve face is movable to partially obstruct an exhaust port in fluid communication with the first cylinder. A pivot member is secured to the first valve body for movement of the first valve body within a recess adjacent to the cylinder. The recess has top and bottom surfaces within which the body moves in a limited range of motion less than 90 degrees.

The first valve body may include a side extension with a side valve face. The side valve face is adjacent a side exhaust port. The side extension moves with the first valve body.

A second valve body may also be provided adjacent to a second cylinder wall of a second cylinder of the engine. Similar to the first valve body, the second valve body has a second main face movable to partially obstruct a second exhaust port in fluid communication with the second cylinder. The first and second valve bodies may be coupled together such that they move together. First and second lever arms are provided to rotate the first and second valve bodies. The lever arms are preferably driven by a cable secured to a mounting bracket.

### BRIEF DESCRIPTION OF THE DRAWINGS

Preferred and alternative examples of the present disclosure are described in detail below with reference to the following drawings:

FIG. 1A is an isometric view of an exhaust valve in accordance with an embodiment of the present disclosure;

FIG. 1B is a lower isometric view of the exhaust valve in accordance with an embodiment of the present disclosure;

FIG. 2 is an isometric view of a cylinder and exhaust port of a two-stroke engine for receiving the exhaust valve in accordance with an embodiment of the present disclosure;

FIGS. 3 and 4A are isometric views of the cylinder and exhaust port having the exhaust valve installed in accordance with an embodiment of the present disclosure;

FIG. 4B is an exploded view of the valve assembly;

FIG. 4C is an assembled view of the valve assembly before insertion;

FIGS. 4D and 4E show the valve assembly dropped into the recess;

FIG. 4F shows the valve assembly in the recess next to the cylinder;

FIGS. 4G and 4H illustrate a two-cylinder engine with two coupled valve assemblies;

FIG. 4I shows an exemplary mounting bracket;

FIG. 5 is an isometric view of the exhaust valve and exhaust and intake ports with the exhaust valve closed in accordance with an embodiment of the present disclosure;

FIG. 6 is an isometric view of the exhaust valve and exhaust and intake ports with the exhaust valve open in accordance with an embodiment of the present disclosure;

FIG. 7 is a partial cutaway view of a piston and the exhaust valve in accordance with an embodiment of the present disclosure;

FIG. 8 is a schematic diagram of the exhaust valve and cylinder in accordance with an embodiment of the present disclosure;

FIGS. 9A and 9B are cross-sectional views of a cylinder with the exhaust valve closed accordance with an embodiment of the present disclosure;

FIGS. 10A and 10B are cross-sectional views of a cylinder with the exhaust valve open accordance with an embodiment of the present disclosure;

FIG. 11 is a schematic block diagram of components for controlling a two-stroke engine in accordance with an embodiment of the present disclosure;

FIG. 12 is a schematic block diagrams illustrating a system for calculating an exhaust valve position in accordance with an embodiment of the present disclosure;

FIG. 13 is a table illustrating variation in exhaust valve position with respect to engine load and engine speed in accordance with an embodiment of the present disclosure;

FIG. 14 is a table illustrating exhaust valve position correction based on engine temperature in accordance with an embodiment of the present disclosure;

FIG. 15 is a table illustrating exhaust temperature with respect to engine load and engine speed in accordance with an embodiment of the present disclosure; and

FIG. 16 is a plot illustrating engine power with respect to speed both with and without continuous variation of exhaust valve position in accordance with an embodiment of the present disclosure.

### DETAILED DESCRIPTION

An exhaust valve according to embodiments disclosed herein is provided that comprises a rotatable valve body including a first valve that is selectively positionable along an exhaust port of a cylinder, and optionally at least one auxiliary valve selectively positionable along an auxiliary exhaust port of the cylinder. The position of the auxiliary valve on the valve body may be fixed with respect to the position of the first valve on the valve body.

The exhaust valve 10 according to the embodiments disclosed herein may be understood with respect to an axial direction 12a, a radial direction 12b, and a circumferential direction 12c. The axial direction 12a may be defined as substantially (e.g., within 2 degrees of) parallel to the axis of rotation 14 of the exhaust valve 10. The axial direction 12a may also be defined as substantially (e.g., within 2 mm of) colinear with the axis of rotation 14 of the exhaust valve 10.

The exhaust valve 10 may include a central valve surface 16. The valve surface 16 may conform to an arcuate shape rotated in the circumferential direction 12c about the axis of rotation 14. The valve surface 16 may conform to a toroidal shape, such as a circular toroid (i.e., torus) having a radius of revolution (R) and a section radius (r). For example, each point on the valve surface 16 may be within 0.1 mm of a toroidal shape. In such embodiments, the valve surface 16 is concave in planes intersecting and parallel to the axis of rotation 14. The section radius r corresponds to the radius of the cylinder with which the exhaust valve 10 is used. For example, r may be equal to the radius of the cylinder. In other embodiments, r is equal to the radius of the cylinder plus a non-zero tolerance X, where X is a value between 0.1 and 2 percent of r.

The exhaust valve 10 defines a perimeter 18 that is the boundary of the central valve surface 16 that conforms to the toroidal shape. The perimeter 18 may have a shape corresponding to the exhaust port with which it is used. For example, the perimeter 18 may have a width that is equal to the width of the exhaust port parallel to the axial direction 12a plus an additional amount such that the valve surface 16 extends outwardly on either side of the exhaust port. The arc length of the perimeter 18 parallel to the circumferential direction 12c at the center of the perimeter 18 along the axial direction 12a may be less than or equal to the height of the exhaust port inasmuch as the exhaust port remains open throughout the range of motion of the exhaust valve 10. The shape of the perimeter 18 in the illustrated embodiment is a wedge-shaped section of the toroidal shape. However, other shapes may also be used.

The exhaust valve 10 may include lateral valve surfaces 20a. The lateral valve surfaces 20a may conform to a same or different arcuate shape rotated in the circumferential direction 12c about the axis of rotation 14. For example, the lateral valve surfaces 20a may conform to a cylinder having an axis of symmetry substantially parallel to and substantially colinear with the axis of rotation 14. In other embodiments, the lateral valve surfaces 20a may conform to a cone, circular toroid, other circular shape, or revolution of some other shape about the axis of rotation. The lateral valve surfaces 20a may be formed on fins 20b extending outwardly from the central valve surface 16 and these fins 20b may likewise have cylindrical surfaces opposite the lateral valve surfaces 20a that conform to a smaller cylinder having the axis of symmetry thereof substantially parallel to, and substantially colinear, with the axis of rotation 14.

In some embodiments, the lateral valve surfaces 20a are located closer to the axis of rotation 14 than a major portion of the central valve surface 16. For example, in the illustrated embodiment, the lateral valve surfaces 20a extend no more than between 0 and 5 mm outwardly from a point on the central valve surface 16 that is closest to the axis of rotation 14.

The central valve surface 16 may be formed on an end of a valve body 22. The lateral valve surfaces 20a may be defined by the fins 20b that extend laterally outward from the valve body 22. The valve body 22 may define a recess 24 extending inwardly from the upper surface thereof. The upper and lower surfaces of the valve body 22 may conform to a wedge shape with various features, such as the recess 24 extending inwardly from this wedge shape.

Pivot rods 26 may extend from one or both sides of the valve body 22 and may include cylindrical portions having the axes of symmetry thereof substantially parallel to and substantially colinear with the axis of rotation 14. The pivot rods 26 may each pass through a bearing 28, such as a cartridge bearing, bushing, or other type of bearing. One or both of the pivot rods 26 may be coupled to a lever arm 30 that extends outwardly from the axis of rotation 14 in the radial direction 12b.

The pivot rods 26 may further each pass through seal plates 32, such as through openings 34 defined by the seal plates 32. The portions of the pivot rods 26 passing through the openings 34 may be smaller in diameter than the portions passing through the bearings 28 such that the seal plates 32 hinder movement of the pivot rods 26 along the axial direction 12a. In the illustrated embodiment, the bearings 28 are positioned between the seal plates and the valve body 22. Bushings may alternatively be used in place of bearings 28.

The seal plates 32 may serve to contain exhaust gases and may be made of a heat tolerant material, such as nitrile. In some embodiments, the seal plates 32 are formed of steel covered by nitrile. The seal plates 32 may be made of any material used to form engine gaskets as known in the art. The seal plates 32 may include a curved lower edge 36 and a straight upper edge 38. The lower edge 36 of each seal plate 32 may be shaped to conform to a slot in a cylinder head within which the seal plate 32 is positioned.

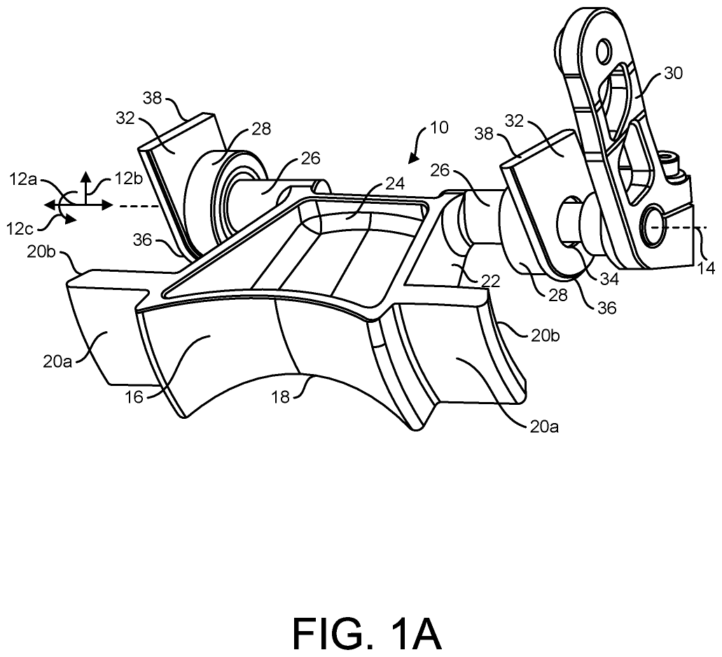

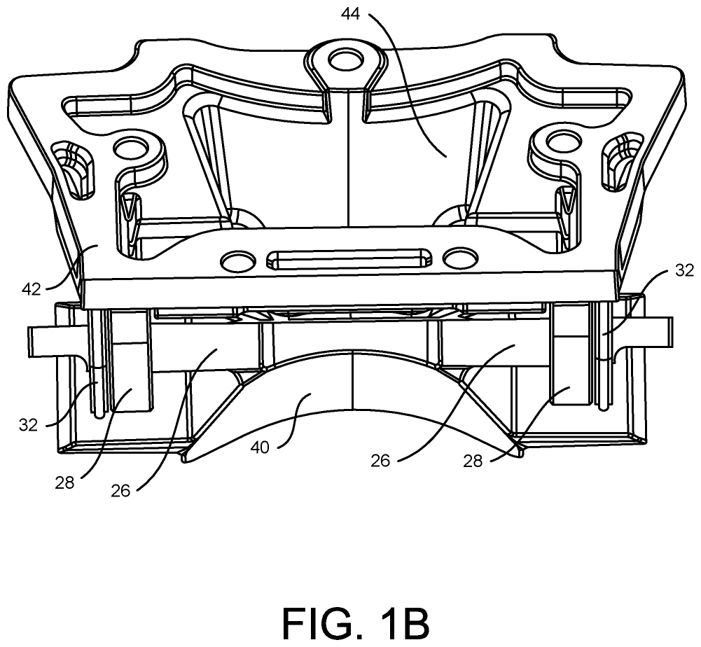

Referring to FIG. 1B, the lower surface 40 of the valve body 22 forms part of the channel through which exhaust gases flow out of the cylinder of the two-stroke engine. In some embodiments, the lower surface 40 may therefore be concave and extend from the central valve surface 16 partially or completely to the axis of rotation 14. In the illustrated embodiment, the concave lower surface 40 intersects the central valve surface 16 and may define the lower edge of the central valve surface along with a chamfered or beveled transition between the concave lower surface 40 and the central valve surface 16.

In the illustrated embodiment, the concave lower surface 40 extends across the pivot rods 26 in the radial direction 12b such that a portion of the concave lower surface 40 extends inwardly from the outer surfaces of the pivot rods 26, such as along the radial direction 12b. The concave lower surface 40 may conform to a cylinder, cone, elliptical rod, or other rounded shape that has a straight or curved central axis. The central axis to which the concave lower surface conforms may be offset from the axis of rotation 14 and the concave lower surface 40 may intersect the axis of rotation 14 or be offset therefrom, such as by between 0 and 10 mm.

FIG. 1B further shows a cover 42 that is used to cover a recess containing the valve 10. The cover 42 may include a recess 44 extending inwardly from an upper surface, thereby defining a protrusion extending outwardly from the lower surface of the cover 42. The protrusion may be sized and positioned to insert within the recess 24 as discussed in greater detail below.

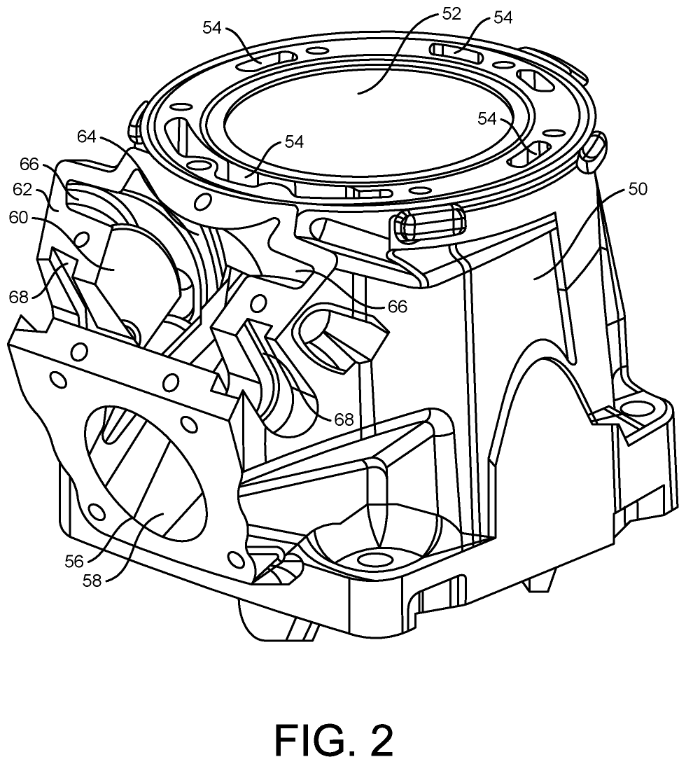

Referring to FIG. 2, the two-stroke engine may include a cylinder head including cylinder wall 50 defining a cylinder 52 within which a piston moves. The cylinder wall 50 may define openings 54 and passageways for receiving the flow of coolant. Alternatively, the two-stroke engine may be air-cooled such that the cylinder wall 50 includes fins for improving heat transfer.

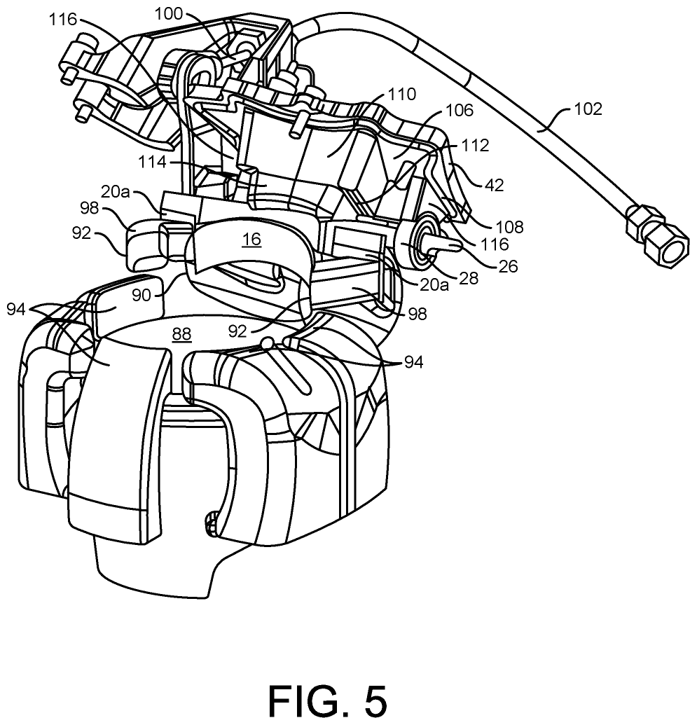

The cylinder wall 50 defines an exhaust opening 56 in fluid communication with an exhaust port (see exhaust port 90 shown in FIGS. 5, 6, and 9A to 10B) intersecting the cylinder 52. The exhaust opening 56 may connect to a muffler directly or by way of an exhaust pipe and/or manifold connected to one or more other cylinder heads. A surface 58 of an exhaust path extends between the cylinder 52 and the exhaust opening 56. The cylinder wall 50 may define an opening 60 above the exhaust path and intersecting the surface 58. The exhaust valve 10 may be inserted into the opening 60. The cylinder wall 50 may define a sealing surface 62 extending completely or partially around this opening 60. For example, the sealing surface 62 may cooperate with the seal plates 32 (see FIGS. 1A and 1B) to restrict flow of exhaust gases when the cover 42 is placed over the sealing surface 62. In the illustrated embodiment, the sealing surface 62 lies on a plane that is at a non-parallel and non-perpendicular angle relative to the axis of symmetry of the cylinder 52. For example, for a first plane to which the axis of symmetry of the cylinder 52 is normal, the sealing surface may lie on a second plane that is at an angle of between 15 and 45 degrees relative to the first plane.

The cylinder wall 50 may define one or more surfaces for engaging with the exhaust valve 10 (FIGS. 1, 3, and 4). For example, the cylinder wall 50 may define a curved or toroidal surface 64 for interfacing with the central valve surface and slots 66 on either side of the toroidal surface 64 for receiving the lateral valve surfaces 20a. The toroidal surface 64 and slots 66 may be sized and positioned to allow the central valve surface 16 and lateral valve surfaces 20a (and fins 20b on which these may be formed) to pass therethrough without contact. In particular, clearances may be between 0.1 and 2 mm to enable free movement while reducing flow of exhaust gases.

The cylinder wall 50 may further define seats 68 for receiving the bearings 28. The seats 68 may also receive the seal plates 32. Alternatively, separate slots may be defined by the cylinder wall 50 for receiving the seal plates 32. The seats 68 or separate slots may be rounded to receive the rounded lower edges 36 of the seal plates 32. A space between the seats 68 may be sized to receive the valve body 22.

In the illustrated example, various features 56-68 are described as being formed in the cylinder wall 50 such that a single monolithic piece of material defines the cylinder 52 as well as the features 56-68. In other embodiments, features 56-68 are formed in one or more different pieces of material that are then fastened to the cylinder wall 50 over the exhaust port.

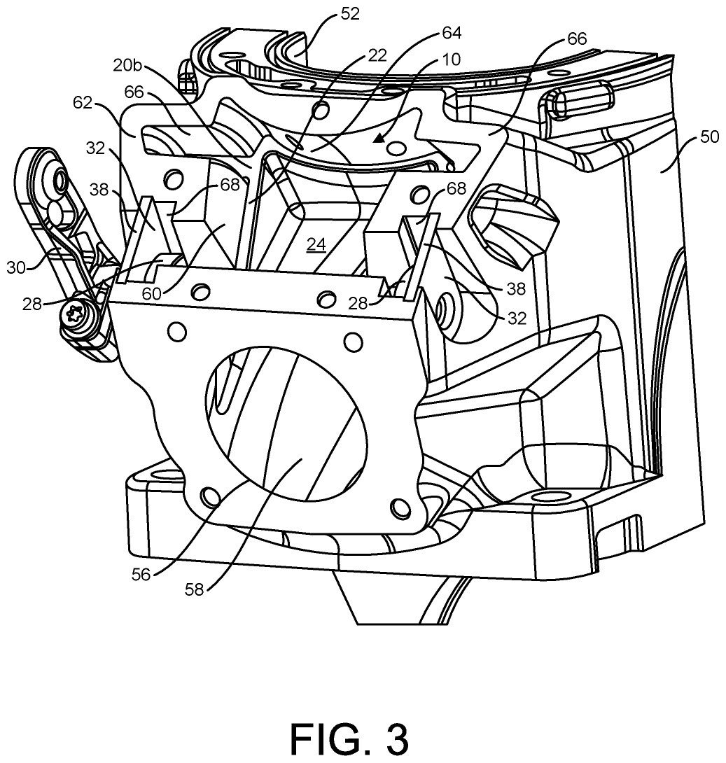

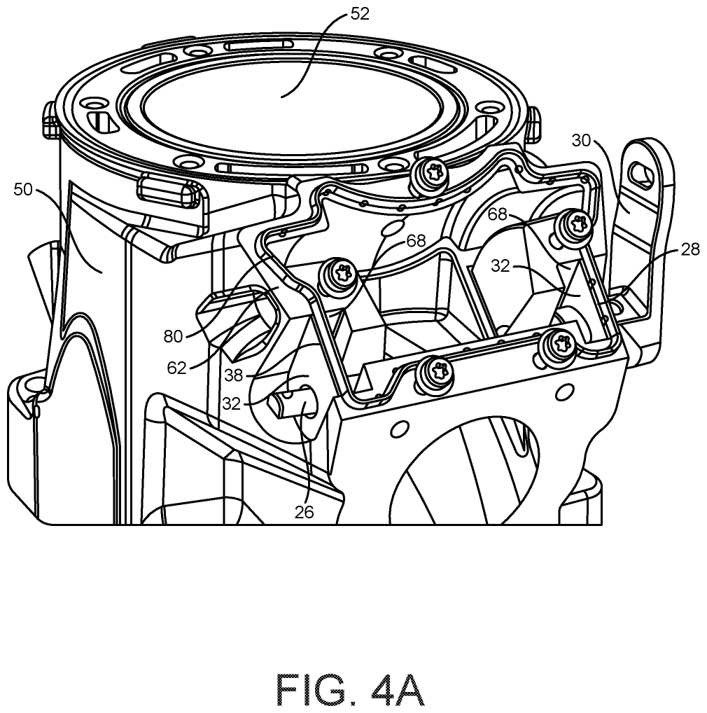

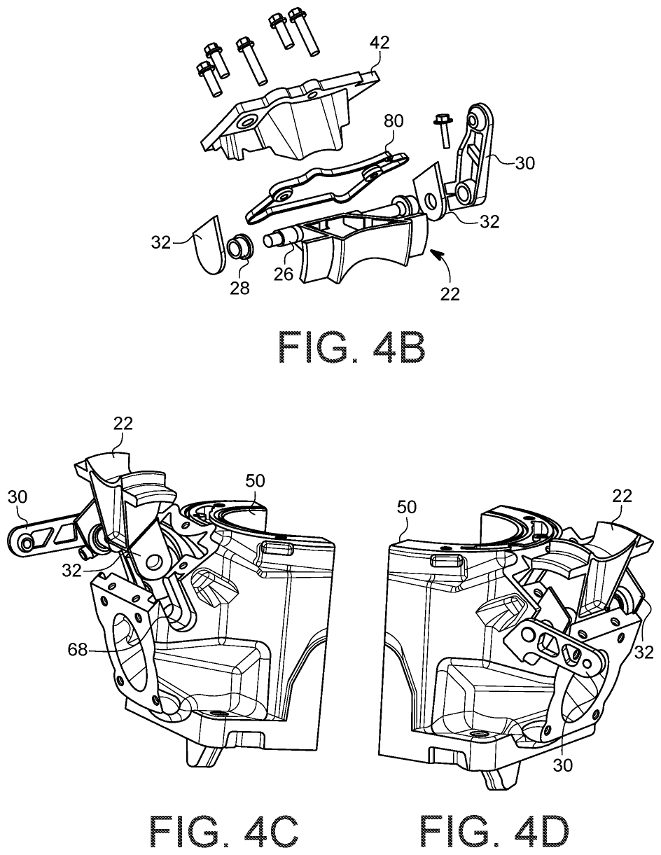

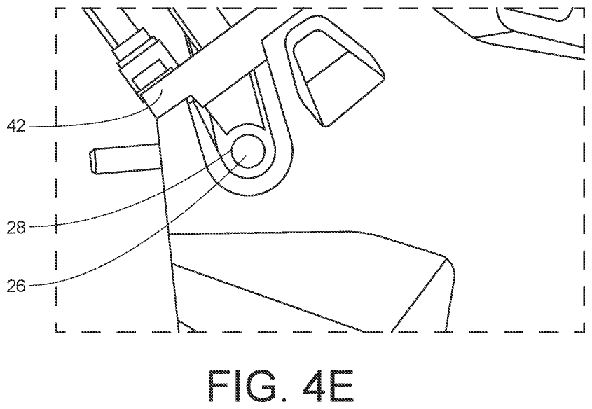

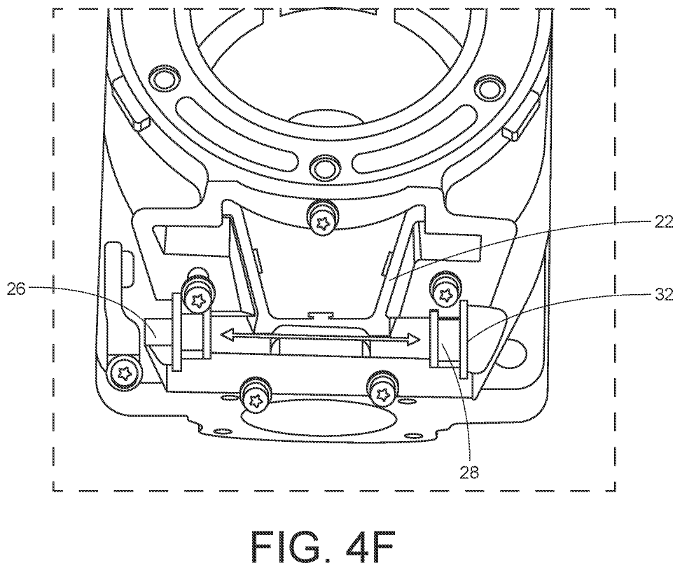

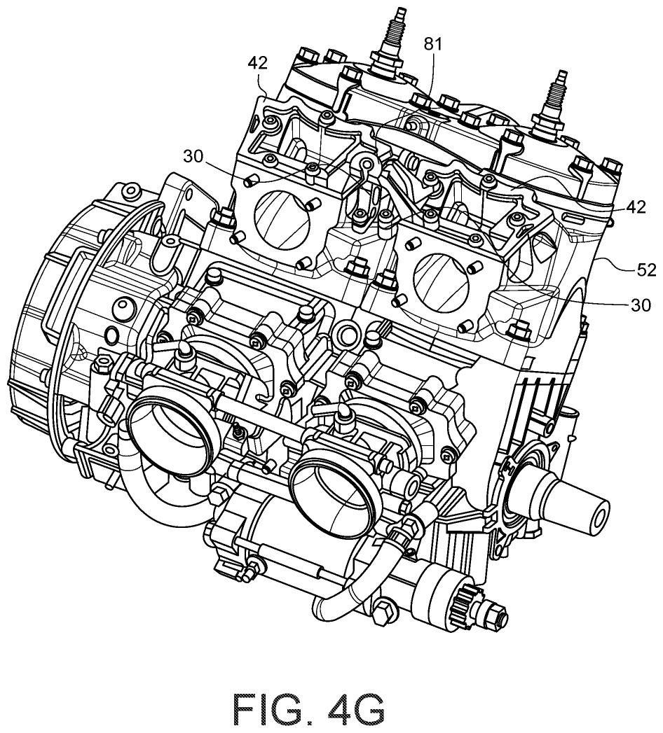

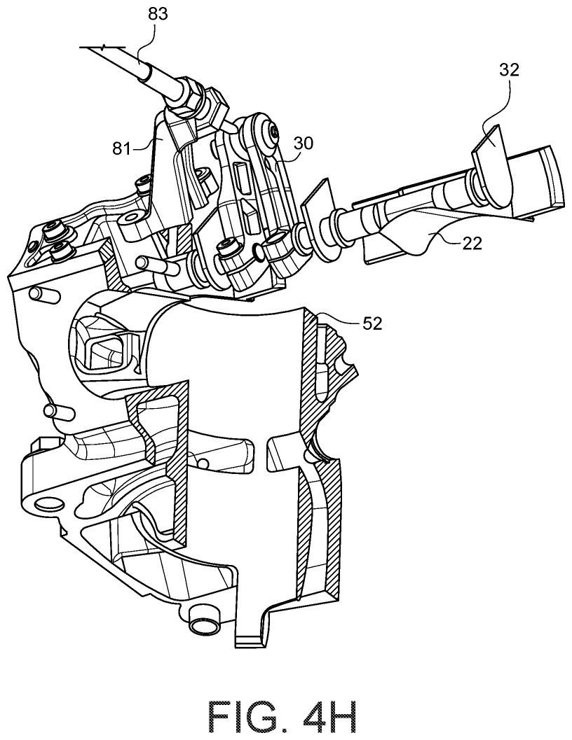

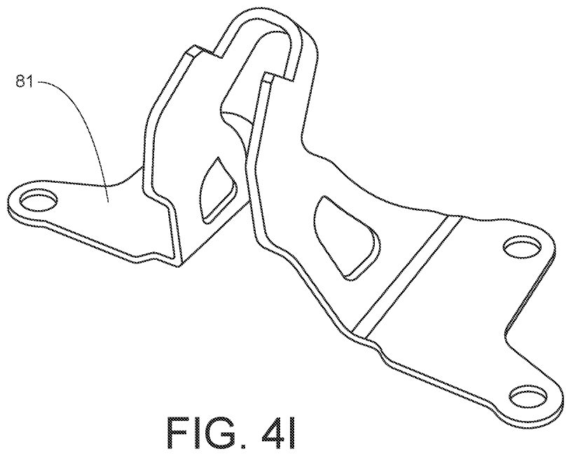

FIGS. 3 and 4A illustrate the exhaust valve 10 following insertion through the opening 60. In the illustrated example, the seal plates 32 are seated within the seats 68, the bearings 28 are positioned within seats 68. The valve body 22 is positioned such that the fins 20b are positioned within the slots 66 and the central valve surface 16 is facing the toroidal surface 64. The pivot rods 26 protrude outwardly from at least one of the seal plates 32 and the lever arm 30 is secured to either the left pivot rod 26 (FIG. 3) or the right pivot rod 26 (FIG. 4.)

As shown in FIG. 4A, a seal or gasket 80 may be positioned on the sealing surface 62 extending around the opening. The gasket 80 may extend across the seats 68 and rest on the seal plates 32, such as the upper edges 38 of the seal plates 32. The gasket 80 may be made using any material known to be usable to make engine gaskets as known in the art. In the illustrated example, the gasket 80 is made of nitrile.

FIG. 4B illustrates an exploded view of the valve assembly that may be inserted into the engine as a single subassembly. The opening to insert the valve assembly into the engine is readily accessible. The combination of the valve body 22 with attached pivot rods 26, bushings 28, seal plates 32 and lever arm 30 may all be assembled together. See FIGS. 4C and 4D. This assembly may be inserted into the opening by sliding seal plates 32 into position within seats 68. The valve body 22 may then be pivoted downwardly into the recess and the cover 42 may be secured into place with the gasket 80 between the sealing surface and the cover 42. This can be repeated for each cylinder.

FIG. 4E shows a downward projection from the cover pressing down on the brass bushing 28 to hold the valve assembly in place.

FIG. 4F shows the valve body 22 with pivot rods 26 captured laterally. Also note the securement of the seal plates 32 and bushings 28 within complementary recesses in the preferred embodiment.

FIG. 4G illustrates a two-cylinder engine with coupled exhaust valves consistent with the above disclosure. A mounting bracket 81 is secured to the engine. Mounting bracket 81 includes an interface to receive a control cable to couple to the lever arms 30 of both exhaust valve assemblies (one for each cylinder). FIG. 4H uses a partially cut-away view to show the details of the two-cylinder valve arrangement. Two lever arms 30 are driven by a control cable 83 to move the two valve bodies 22 in unison. An exemplary mounting bracket is shown in FIG. 4I. It may be stamped, cast, or otherwise formed depending on the material used.

The assembly of the present disclosure is simplified as is any future maintenance or part replacement. The cylinder does not need to be split in any way. The valve does not need to be fed through any exhaust port. Once assembled as noted above, the lever arm may be coupled to a control cable or arm. The preferred cable embodiment adjusts the valve positioning with no sliding contact surfaces and extremely low friction and inertia.

This valve arrangement allows for larger exhaust port openings with fewer valve parts per cylinder. One valve body controls three ports. A preferred embodiment provides a 6.7 mm to 16.8 mm port height change. In the preferred embodiment, the crevice between the cylinder wall and the valve face varies between 7.7 mm and 3.1 mm. Thus, the gases are tightly controlled for efficient operation with smooth flow.

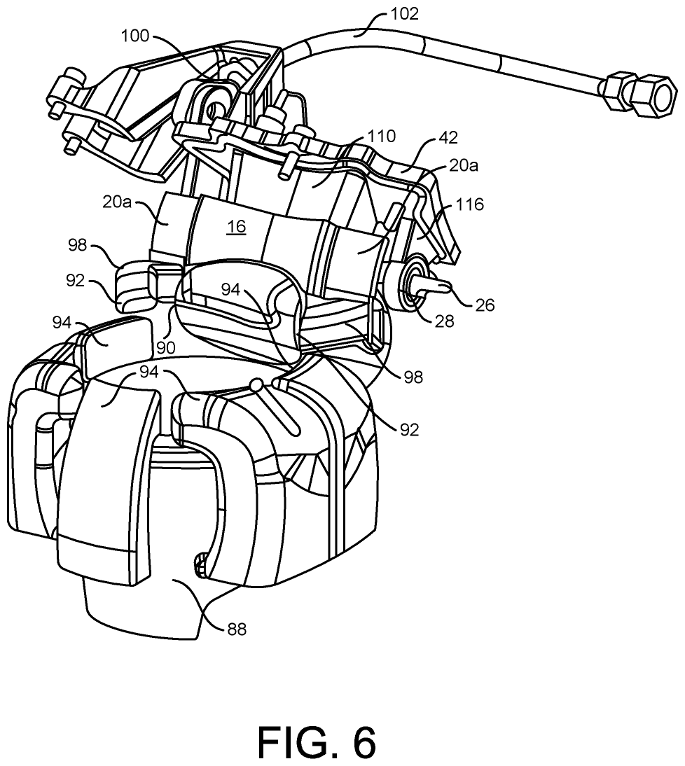

FIGS. 5 and 6 illustrate operation of the exhaust valve 10. FIGS. 5 and 6 illustrate the piston 88 of a two-stroke engine. The cylinder wall 50 has been removed in the views of FIGS. 5 and 6 to show the configuration of a central exhaust port 90, lateral exhaust ports 92, and intake ports 94 that are defined by the cylinder wall 50. The central exhaust port 90 and lateral exhaust ports 92 are in fluid communication with the exhaust path formed at least partially by the lower surface 58 of the exhaust path and the lower surface of the valve body 22. The exhaust ports 90 are positioned above the intake ports 94 (further from the crank shaft and closer to the top dead center (TDC) position of the piston 88). Although multiple intake ports 94 are shown, a single intake port 94 may be used in some implementations. As is apparent, the lateral valve surfaces 20a are offset outwardly from the lateral ports 92 and may be connected to the lateral ports 92 by channels 98 passing through the cylinder wall 50. Each channel 98 may pass through one or more surfaces defining one of the slots 66.

FIGS. 5 and 6 further show a connector 100 for connecting an actuator to the lever arm 30. In the illustrated embodiment, the connector 100 is embodied as a flexible rod or cable within a sleeve 102. The connector 100 may be coupled to an electrical motor, solenoid, pneumatic piston, hydraulic piston, mechanical governor, or other driving mechanism. The connector 100 may pull on the lever 30 such that increasing tension results in raising of the valve body 22 and increasing the effective size and height of an exhaust port. Where the connector 100 is a flexible rod, the rod may be placed in compression to drive the valve body 22 down and decrease the effective size and height of the exhaust port. In other embodiments a spring or other biasing member engages the lever 30 and urges the valve body 22 down in the absence of tension on the connector 100. In other embodiments, the connector 100 is a tube conducting pressurized air or hydraulic fluid and a pneumatic or hydraulic piston that is connected to the lever arm 30 and is driven by fluid within the connector 100. In other embodiments, the connector 100 is an electrical wire connected to an electric motor or solenoid that is connected to the lever arm 30.

FIGS. 5 and 6 further show an implementation of a cover 42 for the opening 60. A lower surface 106 of the cover 42 interfaces with the sealing surface 62. In the illustrated embodiment, the lower surface 106 defines a groove 108 for receiving the gasket 80. In some embodiments, the upper edges 38 of the seal plates 32 also seat within the groove 108.

A protrusion 110 may extend from the lower surface 106 and be sized to insert within the recess 24. The protrusion 110 may be formed monolithically with the cover 42 or fastened thereto. The protrusion 110 may be hollow and may be formed by the recess 44 extending through the upper surface of the cover 42. In the illustrated embodiment, the protrusion 110 is tapered such that the protrusion 110 becomes smaller in cross section with distance from the lower surface 106 and may include a shoulder 112 that forms a step that extends inwardly and connects to a distal portion 114 that extends outwardly from the shoulder 112 and outwardly from the lower surface 106. The reduced size distal portion 114 may be sized to insert within the recess 24 of the valve body 22. When inserted within the recess 24, the shoulder 112 may press against the upper surface of the valve body 22.

Bearing seats 116 may be secured to the lower surface of the cover 42 by fasteners or monolithic formation therewith. The bearing seats 116 may be positioned on either side of the protrusion 110 and engage the bearings 28 when the cover 42 is installed against the sealing surface 62. Each bearing 26 may therefore be held in place between a bearing seat 68 (FIGS. 3, 4) and a bearing seat 116 (FIGS. 5, 6). The seats 68, 116 may define cylindrical surfaces sized to engage the outer surfaces of the bearings 28 embodied as cartridge bearings.

Referring specifically to FIG. 5, at a first engine RPM, the actuator pivots the exhaust valve 10 to the illustrated lowered configuration in which a portion of the central exhaust port 90 is covered and the lateral ports 92 are completely covered by the lateral valve surfaces 20. Covering the lateral ports 92 may include covering openings of the channels 98 opposite the lateral ports 92. As used herein, “completely” covering the lateral ports 92 or completely covering the channels 98 may include moving the exhaust valve 10 down (toward the lower surface 58 of the exhaust path) to its lowest position such that the lateral valve surfaces 20a cover at least 90 percent, at least 95 percent, or at least 99 percent, of the area of the lateral ports 92 or openings of the channels 98. Stated differently, in some embodiments, a width of a gap around the perimeter of each lateral valve surface 20a when the exhaust valve 10 is pivoted down to its lowermost position is more than 2 mm, 1 mm, or 0.1 mm at any point on the gap.

Referring specifically to FIG. 6, at a second engine RPM that is higher than the first engine RPM, the exhaust valve 10 is pivoted to the illustrated raised configuration. The second RPM may be between 1000 and 1500 RPM higher than the first RPM for some two-stroke engines. In the raised configuration, the exhaust valve 10 is pivoted to its uppermost position away from the lower surface 58 of the exhaust path. In the illustrated example, the lower edge of the central valve surface 18 is positioned above or flush with the top of the central exhaust port 90. In other implementations, the lower edge of the central valve surface 18 may be slightly below the top of the central exhaust port 90, such as less than 2 mm.

In the lowered configuration, the distal portion 114 of the protrusion 110 may be positioned above the recess 24 whereas in the raised configuration, the distal portion 114 of the protrusion 110 may be positioned within the recess 24 and the shoulder 112 may press against the upper surface of the valve body 22. It may be undesirable in some applications for there to be a void above the valve body 22 when the valve body 22 is in the lowered configuration. A void may result in undesirable resonances and pressure waves and may accumulate unburned fuel that may later ignite. The protrusion 110 may therefore be used to occupy this void at least partially.

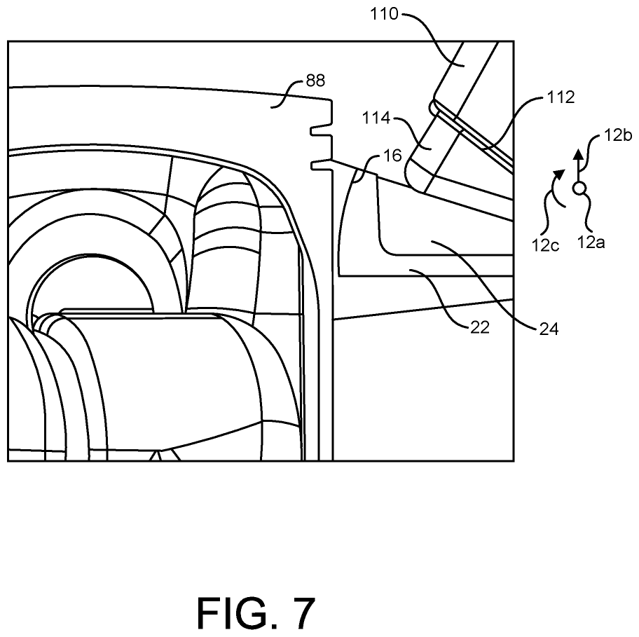

Referring to FIG. 7, when the valve 10 is in the lowered configuration, the central valve surface 16 is adjacent to the piston 88 and may be separated by a gap effective to reduce blow by of fuel-air mixture during the compression. For example, the gap may be chosen to be between 0.1 and 1 mm. In some implementations, the piston 88 and/or piston rings encircling the piston 88 contact the valve surface 16 during operation. Where the valve surface 16 is toroidal, there may be a range of positions of the valve 10 at which the central valve surface 16 is positioned adjacent to the piston 88 separated by the above-mentioned gap or contacting the piston 88. For example, the range may be from 15 to 40 degrees.

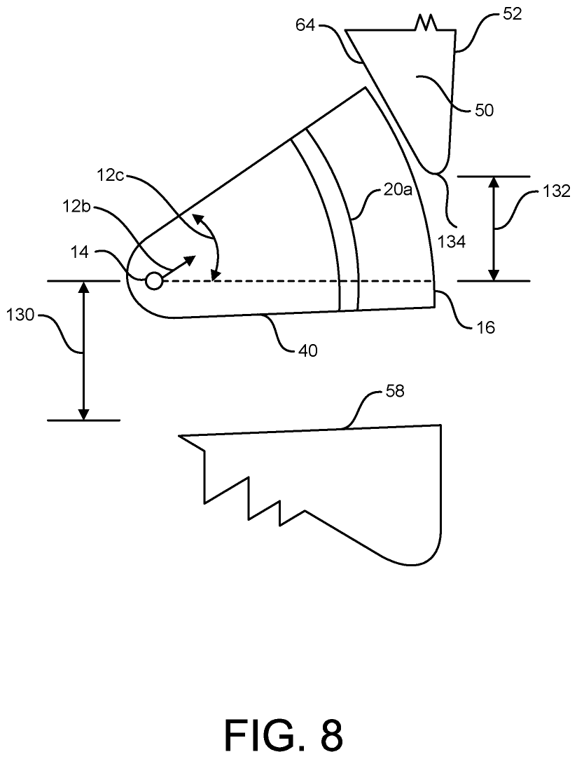

FIG. 8 is a schematic representation of the exhaust valve 10 during use. The axis of rotation 14 may be positioned a distance 130 above the lower surface 58 of the exhaust path and a distance 132 below the top 134 of the central exhaust port 90. As the distance 130 is reduced, the thickness of the cylinder wall connecting to the top 134 of the central exhaust port 90 increases. The distance 130 may be limited by the need to have an exhaust path having sufficient cross-sectional area to conduct exhaust gases out of the cylinder 52.

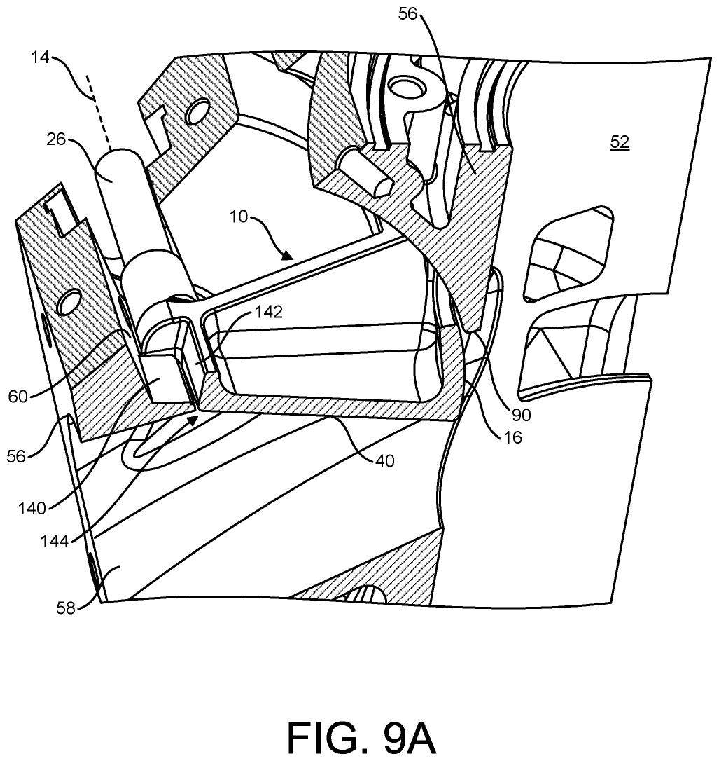

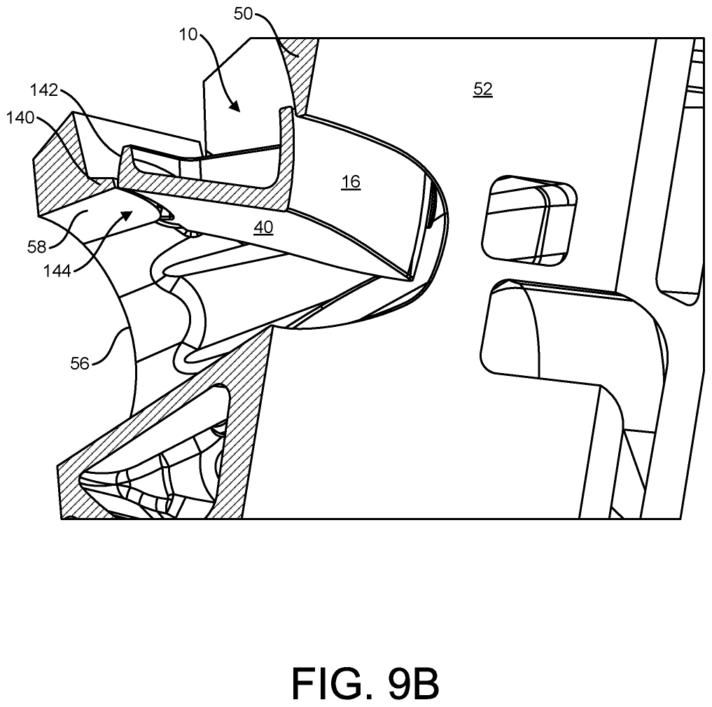

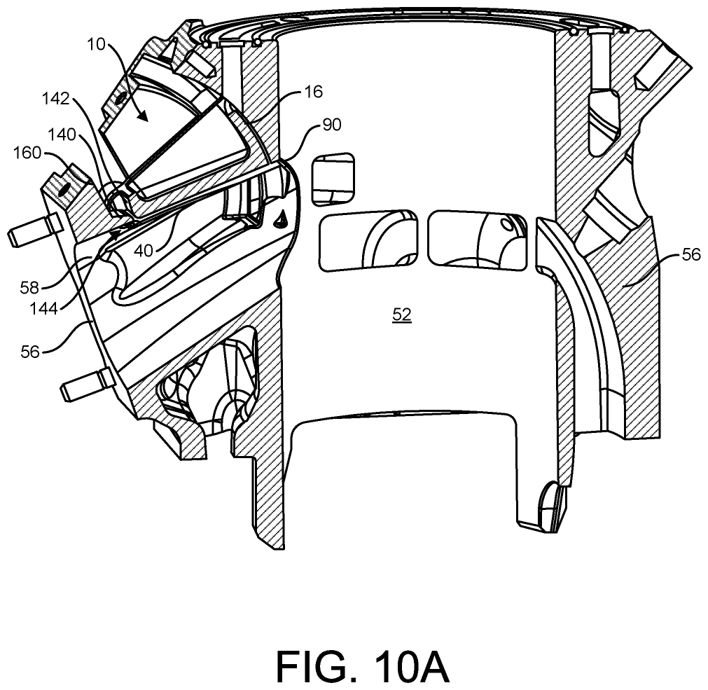

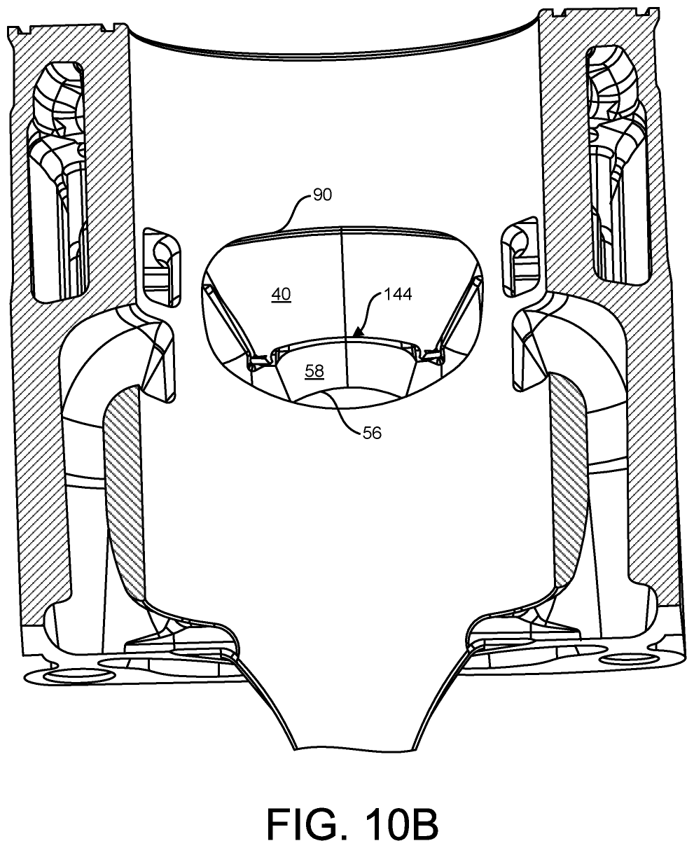

FIGS. 9A, 9B, 10A, and 10B illustrate the exhaust channel defined by the surface 40 of the exhaust valve 10 and the surface 58 defined by the cylinder 50 and/or a structure secured to the cylinder 50.

FIGS. 9A and 9B illustrate the exhaust valve 10 in the lowered configuration. The opening 60 may define a protrusion 140 that extends toward the valve 10. In some embodiments, the valve 10 may define a recess 142 into which the protrusion 140 extends such that a gap 144 is present between the recess 142 and the protrusion 140. The axis of rotation 14 may pass through the recess 142 and may be positioned in or above (e.g., having the valve 10 positioned between the axis of rotation 14 and the surface 58) the gap 144. In this manner, the gap 144 remains substantially (e.g., within 3 mm) uniform through the rotation of the valve 10 between the lowered and raised configurations. In some embodiments, the protrusion 140 and recess 142 are sized and position relative to the axis of rotation 14 such that the gap 144 remains less than 3 mm, less than 2 mm, or less than 1 mm throughout the movement of the valve 10 between the lowered and raised configurations.

The curved lower surface 40 is separated by the gap 144 from the surface 58. At the gap 144 (e.g., within 5 mm of the gap), the curved lower surface 40 may conform to the surface 58, such as having a radius of curvature within 3 mm of that of the surface 58 at the gap (e.g., within 5 mm of the gap). For example, there may be a smooth shape (e.g., cylindrical, conical, horn, or other shape) defined by the surface 58 and the curved lower surface 40 at the gap 144 may be within 3 mm of this surface when in the lowered configuration. In this manner, there is a smooth aerodynamic path from the exhaust port 90 to the exhaust opening 56 with the exception of the gap 144, any gap present between the exhaust valve 10 and the exhaust port 90, and chamfered edges of the exhaust opening 90, exhaust port 90, exhaust valve 10, and recess 142. As used herein, “smooth” shall be understood as having no portion with a radius of curvature smaller than 90 percent of the smallest radius of curvature defined by either of the exhaust port 90 and the opening 56.

FIGS. 9A and 9B also show the smooth valve surface 16 close to the cylinder wall 52. This arrangement promotes smooth flow with low turbulence. The concave face of valve surface 16 allows the valve to be closer to the cylinder wall for improved flow and performance at any valve opening. This arrangement is important since airflow is based around Schnuerle porting. In a present preferred embodiment, the piston opens three exhaust ports first followed by five intake ports. Optimum air flow, fuel mixture, and full burn for low emissions relies on a resonance expansion pipe and tuned exhaust port heights at various engine running parameters, as discussed herein. The preferred flap valve system of the present disclosure allows for large port height adjustments and increased port areas. Thus, the exhaust port may be smaller and lower for increased torque and efficiency or larger and higher for increased engine speed and top-end power as needed. Furthermore, the smooth roof channeling the exhaust flow promotes consistent engine performance with less of the undesirable back pressure and turbulence. This makes for easier tuning of the expansion chamber/pipe.

Referring to FIGS. 10A and 10B, in the raised configuration, the curved lower surface 40 may conform to the smooth shape defined by the surface 58 along a major portion of the extent of the lower surface 40 between the central valve surface 16 and the axis of rotation 14. For example, at least 90 percent of the length of the lower surface 40 between the recess 142 and the central valve surface 16 may lie within 3 mm of the smooth shape defined by the surface 58.

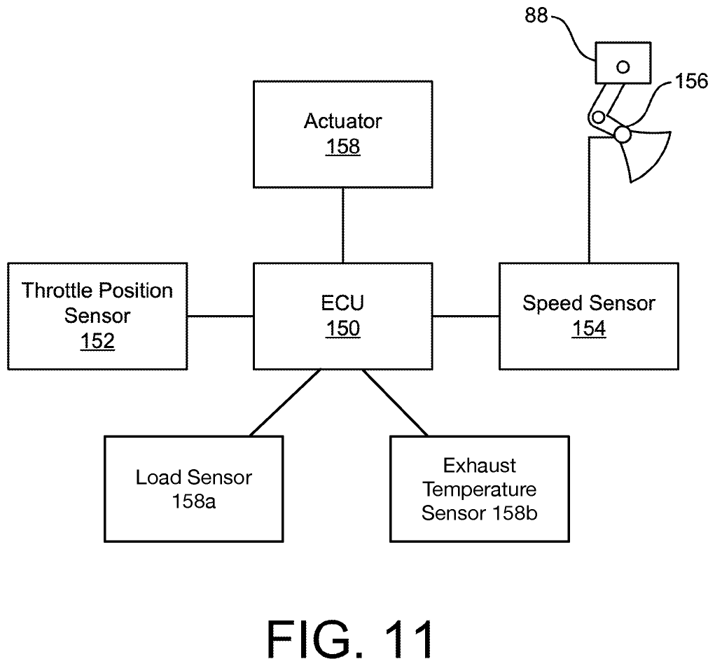

Referring to FIG. 11, the two-stroke engine may be controlled by an engine control unit (ECU) 150 that is a circuit or computing device programmed to perform various control functions. The ECU 150 may be coupled to a throttle position sensor 152 configured to sense a position of a throttle controlling airflow into the crankcase of the two-stroke engine. The ECU may be coupled to a speed sensor 154 configured to sense a speed of rotation of a crankshaft 156 of the two-stroke engine. The crankshaft 156 is coupled to the piston 88 and is rotated thereby. The ECU 150 may be coupled to an actuator 158 coupled to the connector 100. As noted above, the actuator 158 may be an electric motor, solenoid, hydraulic piston, or pneumatic piston connected to the connector 100. In other embodiments, the actuator 158 drives the lever 30 directly rather than through a connector 100.

The ECU 150 may be programmed to control the driver in response to signals received from one or both of the throttle position sensor 152 and the speed sensor 154. As the angular speed of the crankshaft increases as indicated by the speed sensor 154, the ECU 150 causes the actuator 158 to raise the valve body 22 thereby increasing the effective size and height of the exhaust port 90 and opening the lateral exhaust ports 92 (see FIGS. 6-8. As the angular speed of the crankshaft decreases, the ECU 150 may cause the actuator 158 to lower the valve body 22 thereby decreasing the effective size and height of the exhaust port 90 and closing the lateral exhaust ports 92. The ECU 150 may cause the actuator 158 to position the valve body 22 at various positions between the raised configuration and the lowered configuration. The position of the valve body 22 for a given crankshaft speed may be retrieved from a mapping with which the ECU 150 is programmed or calculated by the ECU 150 according to a predefined function. The mapping or function may specify the position of the valve body 22 as a function of both crankshaft angular speed and throttle position.

In some embodiments, the benefits of the exhaust valve 10 may be achieved without the use of an ECU 150. For example, the crankshaft 156 may be connected to a mechanical governor by the connector 100 such that the governor pulls the exhaust valve 10 higher responsive to faster rotation of the crankshaft 156.

Other sensors 158a, 158b may be coupled to the ECU 150 and the outputs thereof may also be used to select the position of the valve body 22. For example, a load sensor 158a may sense torque transmitted by the crankshaft 156. An exhaust temperature sensor 158b may sense a temperature of exhaust gases expelled through an exhaust port, such as the exhaust ports 90, 92. Other sensors may include an oxygen sensor positioned in contact with exhaust gases, or a mass air flow (MAF) sensor positioned in contact with intake gases. Any other sensor that is used to detect the state of an internal combustion engine may also be used.

The ECU 150 may cause rotation of the valve body 22 by the actuator 158 at an angular speed that is less than the angular speed of the crankshaft 156, such as less than half the angular speed. This is not to say that the ECU 150 does not adjust the position of the valve body 22 upon each revolution of the crankshaft 156. However, even where adjustment is performed every revolution, the angular rotation speed of the valve body 22 may remain lower than the angular rotation speed of the crankshaft 156.

The range of motion of the valve body 22 may be limited. For example, the valve body 22 may be limited to a range of rotation less than 90 degrees, less than 45 degrees, less than 30 degrees, or less than 20 degrees.

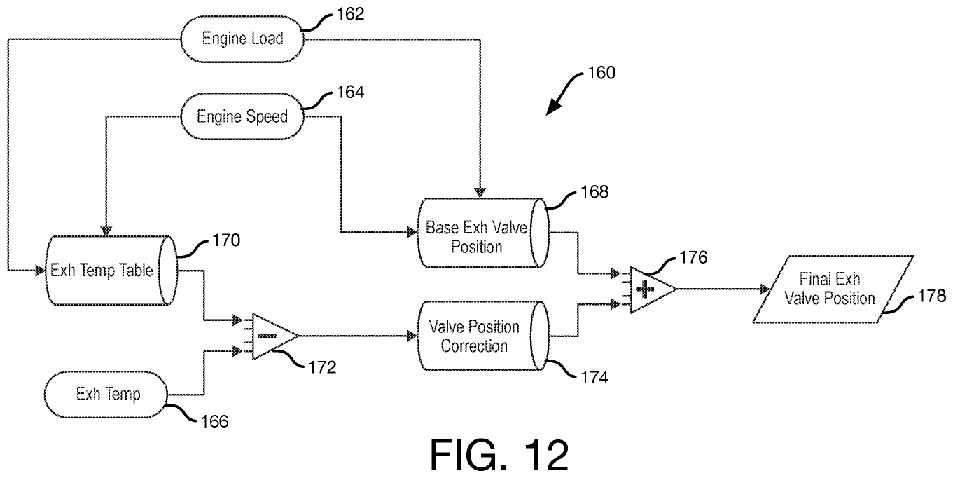

Referring to FIG. 12, the position of the valve body 22 by the actuator 158 within the range of rotation thereof may be continuously variable. As used herein, continuously variable may be understood as varying in increments less than or equal to one of (a) 10 percent of the range of motion of the valve body 22, (b) 1 percent of the range of motion of the valve body 22, (c) 1 degree, (d) 0.1 degree, and (e) 0.01 degree. Continuously variable may also mean subject to a control of an analog controller (e.g., an analog ECU 150) such that any position within the range of rotation of the valve body 22 may be achieved. Continuously variable may also mean variation subject to the control of a digital controller (e.g., a digital ECU 150) such that variation is performed at the minimum increment size permitted by the digital representation of values in the output of the digital controller used to control the actuator 158, e.g., the change in position of the valve body 22 corresponding to a change in the output of the digital controller equal to the unit in last position (ULP) for the digital representation.

The position of the valve body 22 may be selected using the illustrated system 160 or other system 160. The system 160 may be implemented as modules, circuits, method steps, or other software implemented by the ECU 150. The illustrated system 160 is exemplary only. For example, the system 160 or other system 160 may be used to calculate a continuously variable position for the valve body 22 based on some or all of the engine load 162, engine speed 164, and exhaust temperature 166. Other parameters that may be used to calculate the position of the valve body 22 may include ambient air pressure, back pressure on the exhaust system (e.g., resulting from obstruction), throttle position, crank case pressure.

The system 160 selects a base exhaust valve position 168 based on the engine load 162 and engine speed 164. The engine speed 164 may be determined from the speed sensor 154. The engine load 162 may be obtained from the output of the load sensor 158a, which may be implemented as a torque sensor sensing torque transmitted through the output shaft of the two-stroke engine or some other component in a drivetrain driven by the two-stroke engine. The engine load 162 may be inferred based on values such as throttle position, engine speed 164, fuel flow, or other parameters describing operation of the two-stroke engine.

The base exhaust valve position 168 may be computed from the engine load 162 and engine speed 164 by an analog circuit receiving the outputs of analog sensors outputting the engine load 162 and engine speed 164, a digital circuit receiving sampled outputs of the analog sensors, reading an entry of a table corresponding to current values for the engine load 162 and engine speed 164, or some other approach.

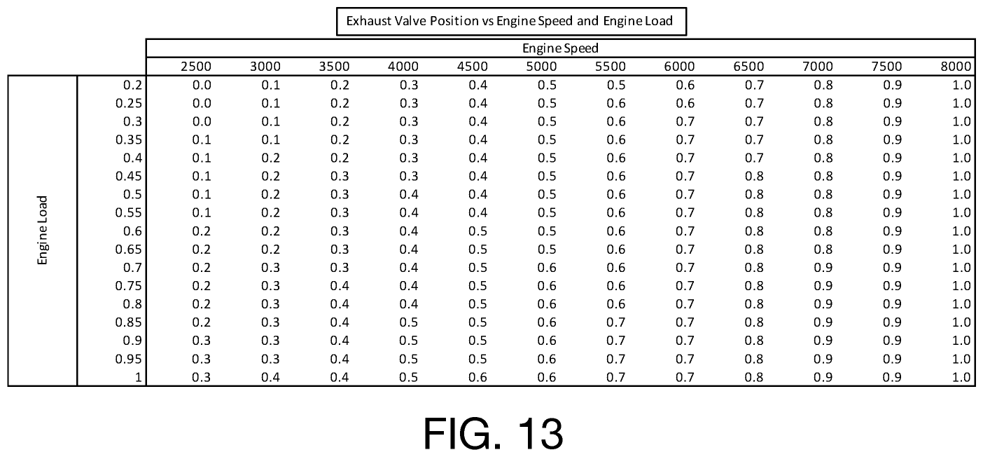

Referring to FIG. 13, the base exhaust valve position 168 may be selected based on engine load 162 and engine speed 164 according to the illustrated table. The listed values for the base exhaust valve position 168 range from 0 (lowered configuration) and 1 (raised configuration), with intermediate values corresponding to positions between the lowered and raised configurations of the valve body 22. In some embodiments, the base exhaust valve positions 168 is interpolated from the values in the table of FIG. 13 based on values of the engine load 162 and engine speed 164 that do not lie precisely on the listed values for the engine load 162 and engine speed 164. From the table of FIG. 13 it can be observed that exhaust valve position increases (rises from the lowered configuration toward the raised configuration) with increase in engine load 162 and with increase in engine speed 164.

Referring again to FIG. 12, in some embodiments, the base exhaust valve position 168 may be adjusted based on the exhaust temperature 166 to account for temperature-dependent changes in the speed of travel of pulses reflected back to the exhaust port (e.g., the exhaust ports 90, 92). The exhaust temperature 166 may be determined from the output of the exhaust temperature sensor 158b.

The power of the two-stroke engine may be increased by a reflected pressure wave from a tuned exhaust system. The reflected pressure wave preferably arrives at the exhaust port (e.g., exhaust ports 90, 92) at a point in the two-stroke cycle at which a fuel-air mixture is flowing or has flowed into the cylinder 52. The reflected pressure wave may therefore reduce the amount of the fuel-air mixture that exits through the exhaust port. Since the speed of sound in a gas is temperature dependent, the tuned exhaust system may not function as well when the tuned exhaust system is at a different temperature, typically a colder temperature, than the temperature for which the exhaust system was tuned. The system 160 may adjust the base exhaust valve position 168 based on the exhaust temperature 166 to at least partially compensate for variation in the temperature of the tuned exhaust system.

For example, the engine load 162 and engine speed 164 may be processed to obtain an expected exhaust temperature for the engine load 162 and engine speed 164. The expected exhaust temperature may be computed from the engine load 162 and engine speed 164 by an analog circuit receiving the outputs of analog sensors outputting the engine load 162 and engine speed 164, a digital circuit receiving sampled outputs of the analog sensors, reading an entry of a table corresponding to current values for the engine load 162 and engine speed 164, or some other approach.

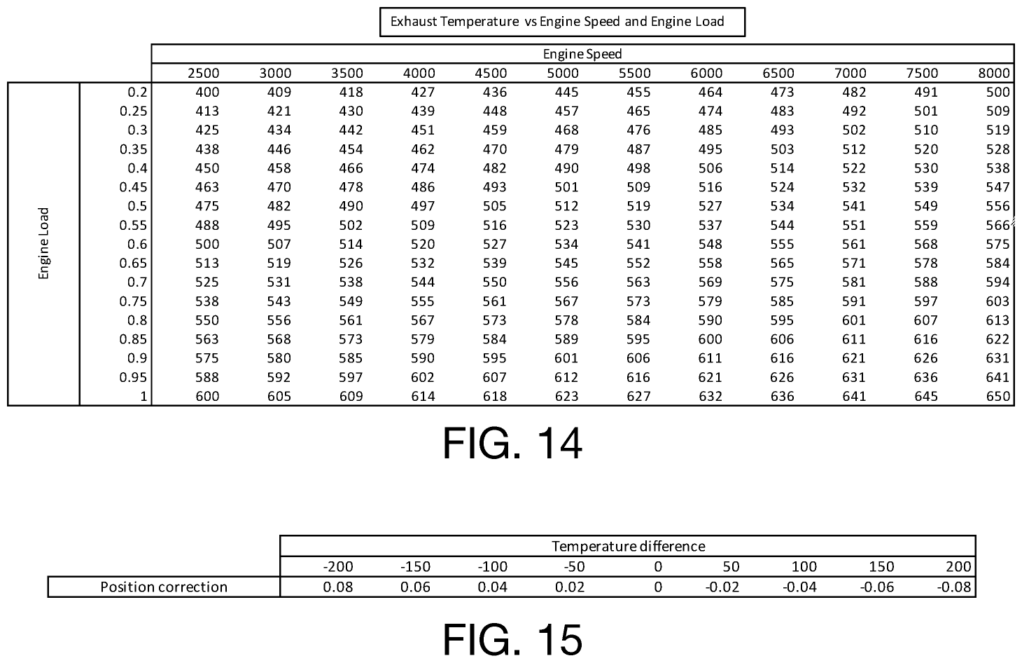

Referring to FIG. 14, the expected exhaust temperature may be selected based on engine load 162 and engine speed 164 according to the illustrated table. In some embodiments, the expected exhaust temperature is interpolated from the values in the table of FIG. 14 based on values of the engine load 162 and engine speed 164 that do not lie precisely on the listed values for the engine load 162 and engine speed 164. From the table of FIG. 13 it can be observed that the expected exhaust temperature increases with an increase in engine load 162 and with an increase in engine speed 164.

Referring again to FIG. 12, the expected exhaust temperature may be evaluated with respect to the exhaust temperature 166, such as by subtracting the expected exhaust temperature from the exhaust temperature 166 to obtain a temperature difference. The temperature difference may then be processed to obtain a valve position correction 174. The valve position correction 174 may be computed by processing the temperature difference using an analog circuit, a digital circuit, reading an entry of a table corresponding to the temperature difference, or some other approach.

For example, referring to FIG. 15, the valve position correction 174 may be selected from the illustrated table based on the magnitude and sign of the temperature difference. In some embodiments, the valve position correction 174 is interpolated from the values in the table of FIG. 15 based on a value of the temperature difference that does not lie precisely on the listed values for the temperature difference in FIG. 15.

Referring again to FIG. 12, the valve position correction 174 may then be combined with the base exhaust valve position 168 to obtain a final exhaust valve position 178. The combination may be performed by an adder 176, multiplication, or some other function.

Once the final exhaust valve position 178 is known, the ECU 150 may cause the actuator 158 to move the valve body 22 according to the final exhaust valve position 178. The final exhaust valve position 178 may be updated continuously, e.g., calculated and used to change the position of the valve body 22 using the actuator 158. As used herein, “updated continuously” may be understood as constant updating by analog circuits implementing some or all of the functions of the system 160. In some embodiments, updating continuously may include updating at a frequency (e.g., Hz) having a magnitude at least as great as that of the speed of the engine (e.g., revolutions per second). In some embodiments, the position of the valve body 22 may be updated at a frequency having a magnitude that is some fraction of that of the speed of the engine, e.g., once every N revolutions of the two-stroke engine, where N is 20 or less, 10 or less, or 2 or less.

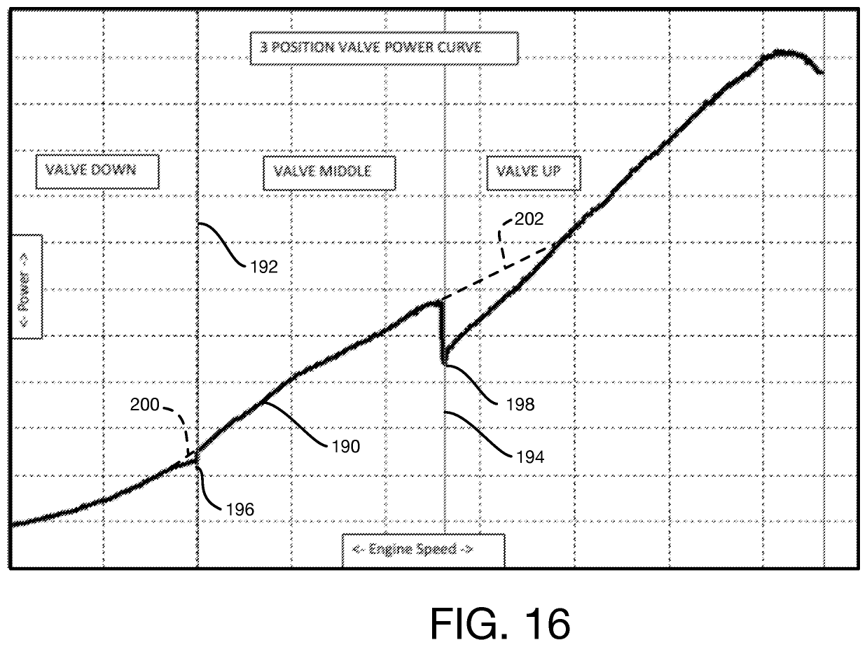

FIG. 16 illustrates a plot 190 of power with respect to engine speed where the valve body 22 is only moved between three positions valve down (lowered configuration), valve middle (halfway between the lowered configuration and the raised configuration), and valve up (raised configuration). The engine speeds about which the exhaust valve positions are moved in the discrete amounts are programmed to move the valve in the region of diminishing engine performance at such valve locations. Thus, the change from valve down to valve middle is preferably at an engine speed in which the power stops steadily increasing. Same for valve middle to valve up position changes. This can provide better performance than a simple two-position valve.

As is readily apparent, in the regions of transitions 192, 194 between the three valve positions, there are pronounced drops 196, 198 in power due to the position of the valve body 22 being far from suitable for the engine speed at the transitions 192, 194. In contrast, by continuously varying the position of the valve body 22 based on engine speed, and possibly loading and/or engine temperature, the power in regions 200 and 202 around the transitions 192, 194 may be raised. Continuously varying the position of the valve body 22 therefore provides overall improved performance and reduces unexpected loss of power.

FIG. 16 does not show torque, but such is increased with the valve down position at lower engine speeds. Thus, starting torque is good whereas power is also good as the engine speed increases. This can be accomplished by multiple discrete positions of the valve timed for desired performance or, even better, by continuously variable valve positioning.

The illustrated system 160 is exemplary only. The position of the valve body 22 may be continuously varied based on other parameters. For example, a vehicle may have multiple drive modes. In a first drive mode, the valve body 22 is closer to the raised configuration for a given set of operating parameters (e.g., engine load, engine speed, and/or exhaust temperature) than for the same set of operating parameters in a second drive mode. For example, the first drive mode may be an aggressive drive mode prioritizing power whereas the second drive mode is a less aggressive drive mode prioritizing efficiency.

In addition, as noted above, additional parameters may be used to calculate the position of the valve body 22 such as ambient air pressure, back pressure on the exhaust system (e.g., resulting from obstruction), throttle position, crankcase pressure. For example, for a given set of operating parameters the valve body 22 may be moved closer to the raised configuration with increase in ambient air pressure, throttle position, and crankcase pressure to values above baseline ranges for the additional parameters. Likewise, for a given set of operating parameters (e.g., engine load, engine speed, and/or exhaust temperature) the valve body 22 may be moved closer to the lowered configuration with decrease in ambient air pressure, excessive back pressure, throttle position, and crankcase pressure to below baseline ranges for the additional parameters. Generally, engine load may be measured by throttle position and/or crankcase pressure as many of these parameters are interrelated.

The valve assembly and operation in the present disclosure provides advantages in engine performance, manufacturability, robustness, and serviceability. Engine performance is enhanced due to better positioning and geometries of the exhaust openings and valves. Positioning the auxiliary ports further to the sides and using a unitary valve body for the side and main ports allows for more than doubling the possible port height change. This provides increased low-end torque and efficiency without sacrificing high-end power. The auxiliary port height also increases substantially over standard designs. The roof of the exhaust port is smooth with a smooth transition to the face and underside of the flap valve. The valve is contoured to provide a tight clearance to the piston at all valve positions.

As for manufacturability, required machining of parts is reduced. Only the valve faces and pivot interfaces need be machined from the cast valve body part. Assembly is simplified as fewer parts are required and the subassembly easily drops into position from above with a simple cover to install over the valve assembly. This simple assembly with fewer parts improves the robustness of the valve system while also simplifying serviceability.

While the preferred embodiments of the invention have been illustrated and described, as noted above, many changes can be made without departing from the spirit and scope of the invention. Accordingly, the scope of the invention is not limited by the disclosure of the preferred embodiments. Instead, the invention should be determined entirely by reference to the claims that follow.

1. An engine comprising:
a valve body defining an axis of rotation and a central valve surface, the central valve surface conforming to a first shape that is symmetric about the axis of rotation;
a cylinder wall defining:
a cylinder;
a central exhaust port; and
one or more intake ports;
a cavity outside of the cylinder in fluid communication with the central exhaust port and sized to receive the valve body such that the central valve surface is rotatable relative to the central exhaust port between a low position and a high position, the central valve surface covering a greater amount of the central exhaust port in the low position;
a piston positioned within the cylinder;
a crankshaft coupled to the piston;
a speed sensor configured to sense an angular speed of the crankshaft;
an actuator coupled to the valve body; and
an electronic control unit coupled to the speed sensor and the actuator, the electronic control unit programmed to cause the actuator to adjust a position of the valve body in increments of less than or equal to 10 percent of a range of motion of the valve body based on outputs of the speed sensor.

2. The engine of claim 1, wherein the electronic control unit is programmed to cause the actuator to adjust the position of the valve body in increments of less than or equal to 1 percent of the range of motion of the valve body based on the outputs of the speed sensor.

3. The engine of claim 1, wherein the electronic control unit is programmed to cause the actuator to adjust the position of the valve body in increments of less than or equal to 1 degree based on the outputs of the speed sensor.

4. The engine of claim 1, wherein the electronic control unit is programmed to cause the actuator to adjust the position of the valve body in increments of less than or equal to 0.1 degrees based on the outputs of the speed sensor.

5. The engine of claim 1, wherein the electronic control unit is programmed to adjust the position of the valve body at an angular speed of rotation that is less than the angular speed of the crankshaft.

6. The engine of claim 1, wherein the electronic control unit is programmed to calculate the position of the valve body at least once per revolution of the crankshaft.

7. The engine of claim 1, wherein the electronic control unit is programmed to sense loading of the crankshaft and to adjust the position of the valve body based on both of the outputs of the speed sensor and the loading.

8. The engine of claim 7, wherein the electronic control unit is programmed to move the valve body closer to the high position with increasing engine speed as indicated in the outputs of the speed sensor.

9. The engine of claim 8, wherein the electronic control unit is programmed to move the valve body closer to the high position with increasing of the loading.

10. The engine of claim 7, wherein the electronic control unit is programmed to sense an exhaust temperature of an exhaust temperature of exhaust expelled through the central exhaust port and to adjust the position of the valve body based on both outputs of the speed sensor and the exhaust temperature.

11. The engine of claim 10, wherein the electronic control unit is programmed to:
calculate an expected temperature based on the loading the outputs of the speed sensor;
obtain a difference between the exhaust temperature and the expected temperature; and
adjust the position of the valve body based on the difference.

12. The engine of claim 1, wherein the central valve surface does not completely cover the central exhaust port when in the low position.

13. The engine of claim 1, wherein:
the first shape is a circular toroid;
the valve body further comprises a first lateral valve surface defined by the valve body, the first lateral valve surface conforming to a second shape that is different from the first shape and that is symmetric about the axis of rotation; and
the valve body further comprises a second lateral valve surface defined by the valve body, the central valve surface being positioned between the first lateral valve surface and the second lateral valve surface, the second lateral valve surface conforming to a third shape that is different from the first shape and that is symmetric about the axis of rotation, the second shape and the first shape each being a cylinder.

14. The engine of claim 1, wherein the cavity is accessible above the exhaust port, the valve body being removable from above.

15. The engine of claim 1, further comprising a second valve body positioned adjacent a second cylinder.

16. A method for controlling a two-stroke engine comprising:
measuring a speed of the two-stroke engine; and
adjusting, by a controller, a position of a valve body controlling opening of an exhaust port of the two-stroke engine in an increment of less than or equal to 10 percent of a range of motion of the valve body based on the speed.

17. The method of claim 16, further comprising:
measuring a loading of the two-stroke engine; and
adjusting, by the controller, the position of the valve body based on the speed and the loading.

18. The method of claim 17, further comprising:
measuring an exhaust temperature of the two-stroke engine; and
adjusting, by the controller, the position of the valve body based on the speed, the loading, and the exhaust temperature.

19. The method of claim 18, further comprising:
calculating, by the controller, an expected temperature based on the loading and the speed of the two-stroke engine;
obtaining, by the controller, a difference between the exhaust temperature and the expected temperature; and
adjusting, by the controller, the position of the valve body based on the difference.

20. The method of claim 16, further comprising adjusting, by the controller, the position of the valve body at an angular speed of rotation that is less than the speed of the two-stroke engine.

21. The method of claim 16, further comprising calculating, by the controller, the position of the valve body at least once per revolution of a crankshaft of the two-stroke engine.

22. The engine of claim 1, wherein the central valve surface does not completely cover the central exhaust port when in the low position.

23. A method for installing an exhaust valve in an engine comprising:
inserting an exhaust valve assembly including a valve body and pivot rod into an opening adjacent a cylinder of the engine, the opening being above an exhaust port of an engine; and
fastening a cover above the valve assembly and covering the opening.

24. The method of claim 23, further comprising securing bushings on the pivot rod before inserting the valve assembly into the opening.

25. The method of claim 23, wherein the cover is removable without removal of a cylinder head.

26. The method of claim 23, wherein the cover is removable without removal of another exhaust component.

27. An exhaust valve assembly for an engine comprising:
a first valve body having a first main valve face positioned adjacent a first cylinder wall of the engine, the first valve face movable to partially obstruct an exhaust port in fluid communication with the first cylinder wall; and
a pivot member secured to the valve body for movement of the valve body, the valve body being secured within a recess adjacent to the first cylinder wall, the recess having a top surface and a bottom surface within which the valve body moves in a limited range of motion less than 90 degrees.

28. The exhaust valve assembly of claim 27, wherein the valve body further includes a side extension with a side valve face adjacent a side exhaust port, the side extension moving with the first valve face of the valve body.

29. The exhaust valve assembly of claim 27, further comprising:
a second valve body having a second main valve face positioned adjacent a second cylinder wall of the engine, the second valve face being movable to partially obstruct an exhaust port in fluid communication with the second cylinder wall.

30. The exhaust valve assembly of claim 29, wherein the first valve body and the second valve body are coupled together to move together.

31. The exhaust valve assembly of claim 30, wherein a first lever arm is coupled to the first valve body to rotate the first valve body about the pivot member.

32. The exhaust valve assembly of claim 31, wherein the second valve body is coupled to a second lever arm, the first and second lever arms being coupled together and driven by a control cable.
